(19) United States
(12) Patent Application Publication
(10) Pub. No.: US 2004/0206201 A1
(43) Pub. Date: Oct. 21, 2004

(54) Flywheel assembly

(76) Inventors: Hiroyoshi Tsuruta, Osaka (JP); Hiroshi Uehara, Osaka (JP)

Correspondence Address: SHINJYU GLOBAL IP COUNSELORS, LLP, 1233 20TH STREET, NW, SUITE 700, WASHINGTON, DC, 20036-2680, US

(21) Appl. No.: 10/823,709

(22) Filed: Apr. 14, 2004

(30) Foreign Application Priority Data
Apr. 17, 2003 (JP) 2003-113115
Dec. 4, 2003 (JP) 2003-405316

(51) Int. Cl. F16F 15/10

(52) U.S. Cl. 74/574

(57) ABSTRACT

The flywheel assembly for transmitting torque from the crankshaft 191 of the engine has a second flywheel 103, a damper mechanism 104 and a support member 119. The damper mechanism 104 elastically connects the second flywheel 103 to the crankshaft 191 in the rotational direction. The support member 119 supports and positions the second flywheel 103 on the crankshaft 191 in the radial direction.

### BACKGROUND OF THE INVENTION

1. Field of the Invention

The invention relates to a flywheel assembly. More specifically, the present invention relates to a flywheel assembly in which a flywheel is connected to the crankshaft through a damper mechanism.

2. Background Information

Conventionally, a flywheel is attached to a crankshaft of an engine for absorbing vibrations caused by variations in engine combustion. Further, a clutch device is arranged on a transmission side (i.e., in a position axially shifted toward the transmission) with respect to the flywheel. The clutch device usually includes a clutch disk assembly coupled to an input shaft of the transmission, and a clutch cover assembly for biasing the frictional coupling portion of the clutch disk assembly toward the flywheel. The clutch disk assembly typically has a damper mechanism for absorbing and damping torsional vibrations. The damper mechanism has elastic members such as coil springs arranged to compress in a rotating direction.

A structure is also known in which the damper mechanism is not arranged in the clutch disk assembly, and rather is arranged between the flywheel and the crankshaft. In this structure, the flywheel is located on the output side of a vibrating system, in which the coil springs form a border between the output and input sides, so that inertia on the output side is larger than that in other prior art. Consequently, the resonance rotation speed can be lower than an idling rotation speed so that damping performance is improved. The structure, in which the flywheel and the damper mechanism are combined as described above, provides a flywheel assembly or a flywheel damper.

In the flywheel assembly described above, the flywheel needs to be positioned in the radial direction or centered accurately because the flywheel is connected to the crankshaft through the damper mechanism. Typically, the structure for centering the flywheel is complicated, or the structure is a part of other members so that it cannot achieve high accuracy of centering.

In view of the above, it will be apparent to those skilled in the art from this disclosure that there exists a need for an improved flywheel assembly. This invention addresses this need in the art as well as other needs, which will become apparent to those skilled in the art from this disclosure.

### SUMMARY OF THE INVENTION

An object of the present invention is to simplify a flywheel assembly structure to center a flywheel relative to a crankshaft.

An alternate object of the present invention is to improve the accuracy of centering a flywheel.

According to a first aspect of the present invention, a flywheel assembly that transmits torque from a crankshaft of the engine, includes a flywheel, a damper mechanism, and a support member. The damper mechanism elastically connects the flywheel to the crankshaft in the rotational direction. The support member supports and positions the flywheel on the crankshaft in the radial direction. In this flywheel assembly, the flywheel is elastically connected to the crankshaft in the rotational direction and centered relative to the crankshaft in the radial direction by the support member. The structure for centering the flywheel is simpler than that of the prior art because the support member is composed of a single independent member.

A flywheel assembly in accordance with a second aspect of the present invention is the flywheel assembly of the first aspect, wherein the flywheel is formed with an inner circumferential surface, and the support member is formed with an outer circumferential surface opposing the inner circumferential surface in the radial direction.

A flywheel assembly in accordance with a third aspect of the present invention is the flywheel assembly of the first aspect, wherein the support member has a cylindrical support portion having the outer circumferential surface, thereby realizing a simple structure.

A flywheel assembly in accordance with a fourth aspect of the present invention is the flywheel assembly of the third aspect, wherein the flywheel assembly further includes a radial bearing disposed between the outer circumferential surface of the support member and the inner circumferential surface of the flywheel, thereby reducing resistance in the rotational direction between the flywheel and the support member.

A flywheel assembly in accordance with a fifth aspect of the present invention is the flywheel assembly of the fourth aspect, wherein the radial bearing is composed of a cylindrical member, thereby realizing a simple structure.

A flywheel assembly according to a sixth aspect of the present invention is the flywheel assembly of any one of the third to fifth aspects, wherein the support member has a fix portion to be fixed to a tip of the crankshaft.

A flywheel assembly according to a seventh aspect of the present invention is the flywheel assembly of the sixth aspect, wherein the fix portion is annular flat disc-like portion and the support portion extends in the axial direction from an edge of the fix portion. The support member is integrally composed of the support portion and the fix portion to realize a simple structure.

A flywheel assembly according to an eighth aspect of the present invention is the flywheel assembly of any one of the first to seventh aspects, wherein the flywheel assembly further inlcudes an inertia member independent of and separate from, i.e. separately formed from, the support member. The work accuracy of the support member may be higher so that the supporting and centering accuracy of the support member for the flywheel is higher because the support member and the inertia member are separately formed.

A flywheel assembly according to a ninth aspect of the present invention is the flywheel assembly of the eighth aspect, wherein the flywheel assembly further includes a fix member to fix the support member and the inertia member with the crankshaft. The number of the components is reduced because the support member and the inertia member are fixed with the crankshaft through the fix member.

A flywheel assembly according to a tenth aspect of the present invention is the flywheel assembly of the eighth or ninth aspect, wherein the support member may be in contact with the inertia member so as to center the inertia member in the radial direction.

A flywheel assembly according to an eleventh aspect of the present invention is the flywheel assembly of any one of the first to eighth aspects, wherein the damper mechanism includes an input member attached to the crankshaft. The input member is independent of and separate from the support member. The work accuracy of the support member may be higher so that the supporting and centering accuracy of the input member for the flywheel is higher because the support member and the input member are separate.

A flywheel assembly according to a twelfth aspect of the present invention is the flywheel assembly of the eleventh aspect, wherein the flywheel assembly further includes a fix member to fix the support member and the input member with the crankshaft. The number of the components is reduced because the support member and the input member are fixed with the crankshaft through the fix member.

A flywheel assembly according to a thirteenth aspect of the present invention is the flywheel assembly of the twelfth aspect, wherein the support member contacts the input member to center the input member in the radial direction.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic cross-sectional view of a clutch device in accordance with a first preferred embodiment of the present invention;

FIG. 2 is an alternate schematic cross-sectional view of the clutch device of FIG. 1;

FIG. 3 is an elevational view of a flywheel assembly of the clutch device of FIG. 1;

FIG. 4 is a schematic cross-sectional view of a clutch device in accordance with a second preferred embodiment of the present invention;

FIG. 5 is an alternate schematic cross-sectional view of the clutch device of FIG. 4;

FIG. 6 is an elevational view of the flywheel assembly of FIG. 1;

FIG. 7 is an enlarged fragmentary cross-sectional view that particularly illustrates a second frictional resistance generating mechanism of the clutch device of FIG. 4;

FIG. 8 is an elevational view of the second friction generation mechanism;

FIG. 9 is an enlarged elevational view of the second friction generation mechanism in FIG. 8;

FIG. 10 is an enlarged cross-sectional view of a first friction generation mechanism of FIG. 4;

FIG. 11 is an enlarged cross-sectional view of the first friction generation mechanism of FIG. 5;

FIG. 12 is an enlarged elevational view of the first friction generation mechanism;

FIG. 13 is an elevational view of a first friction washer of the first friction generation mechanism;

FIG. 14 is an elevational view of an input disk-like plate of a damper mechanism of the clutch device of FIG. 4;

FIG. 15 is an elevational view of a washer of the first friction generation mechanism;

FIG. 16 is an elevational view of a cone spring of the first friction generation mechanism;

FIG. 17 is an elevational view of a second friction washer of the first friction generation mechanism;

FIG. 18 is a view of a mechanical circuit diagram of a damper mechanism and the friction generation mechanisms of the flywheel assembly of FIG. 1;

FIG. 19 is a diagram of torsional characteristics of the damper mechanism and the friction generation mechanisms of the clutch device of FIG. 4;

FIG. 20 is a diagram of torsional characteristics of the damper mechanism and the friction generation mechanisms of the clutch device of FIG. 4;

FIG. 21 is a diagram of torsional characteristics of the damper mechanism and the friction generation mechanisms of the clutch device of FIG. 4; and

FIG. 22 is a diagram of torsional characteristics of the damper mechanism and the friction generation mechanisms of the clutch device of FIG. 4.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### First Embodiment

Structure

Overall Structure

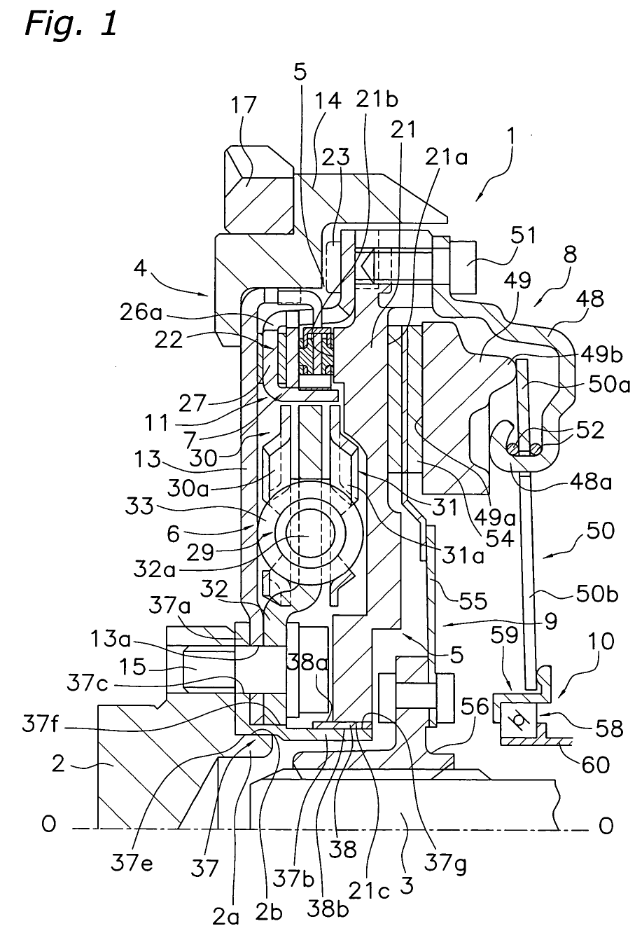

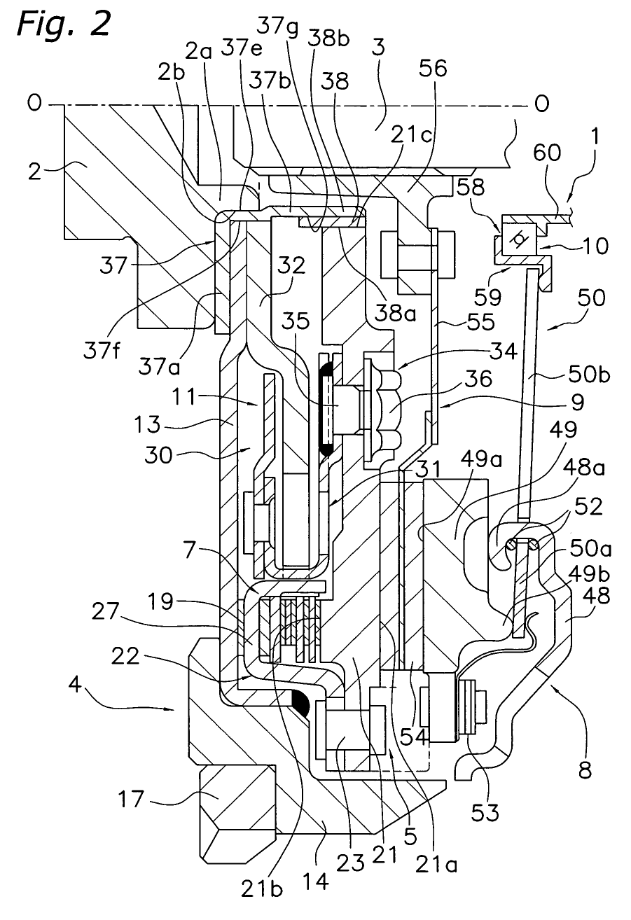

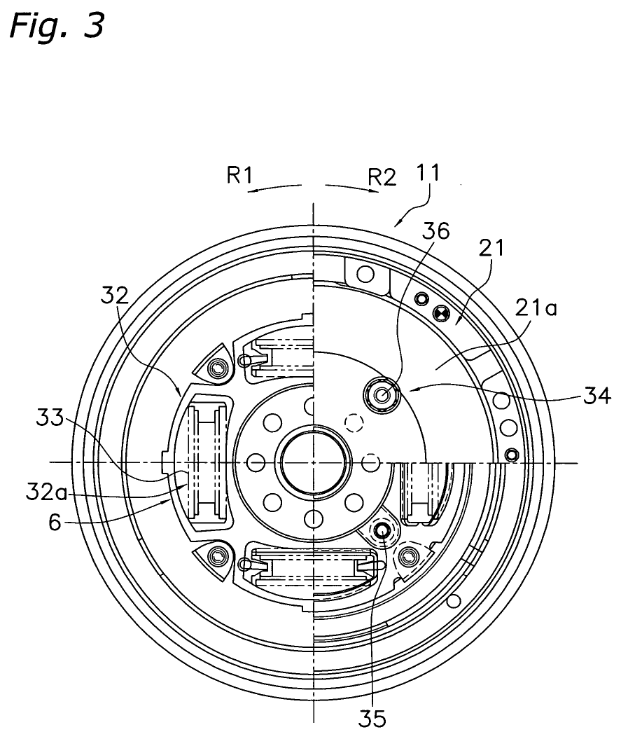

As shown in FIGS. 1 and 2, a clutch device 1 in accordance with a preferred embodiment of the present invention is configured to transmit and to interrupt torque between a crankshaft 2 on an engine side and an input shaft 3 on a transmission side. The clutch device 1 is primarily formed of a first flywheel assembly 4, a second flywheel assembly 5, a clutch cover assembly 8, a clutch disk assembly 9, and a release device 10. The first and second flywheel assemblies 4 and 5 are combined to form a flywheel damper 11, which includes a damper mechanism 6 and is described later.

In FIGS. 1 and 2, O-O indicates a rotation axis of the clutch device 1. An engine (not shown) is disposed on the left side in FIGS. 1 and 2, and a transmission (not shown) is disposed on the right side. In following description, the left side in FIGS. 1 and 2 will be referred to as the engine side, which is based on the axial direction, and the right side will be referred to the transmission side, which is also based on the axial direction.

First Flywheel Assembly

The first flywheel assembly 4 is fixed to the tip of the crankshaft 2. The first flywheel assembly 4 ensures a large moment of inertia on the crankshaft side. The first flywheel assembly 4 principally includes a disk-like member 13, an annular member (inertia member) 14, and a support plate 37 (described hereinafter). The radially inner end of the disk-like member 13 is fixed to the tip of the crankshaft 2 with a plurality of bolts (fix members) 15. Bolt through-holes 13a are formed in the disk-like member 13 in positions corresponding to the bolts 15. The bolts 15 are mounted on the crankshaft 2 from the axial-direction transmission side. The annular member 14 has a thick block shape when viewed cross-sectionally, and is fixed to the axial-direction transmission side on the radially outer end of the disk-like member 13. The radially outer portion of the disk-like member 13 is fixed to the annular member 14 by welding. A ring gear 17 that is provided to facilitate engine startup is fixed to the outer circumferential surface of the annular member 14. The first flywheel assembly 4 may also be constructed as an integral member.

Second Flywheel Assembly

The second flywheel assembly 5 is principally composed of a flywheel 21 with a friction surface and a disk-like plate 22. The flywheel 21 is an annular disk-like member, and is disposed on the axial-direction transmission side of the first flywheel assembly 4. A relatively thick portion of the flywheel 21 having first and second friction surfaces 21a and 21b is disposed near a radially outer portion of the first flywheel assembly 4. The first friction surface 21a is formed on the axial-direction transmission side of the flywheel 21. The first friction surface 21a is an annular, flat surface, and is a portion that is engaged by a clutch disk assembly 9 described hereinafter. The second friction surface 21b is arranged axially opposite the first friction surface 21a to face the disk-like member 13.

The disk-like plate 22 is disposed axially between the first flywheel assembly 4 and the flywheel 21. A radially outer portion of the disk-like plate 22 is fixed to a radially outer portion of the flywheel 21 through a plurality of rivets 23 so that the disk-like plate 22 rotates integrally with the flywheel 21. The disk-like plate 22 has an annular portion 27 that axially opposes the second friction surface 21b of the flywheel 21 with a space therebetween. Within this space, a plurality of components of the frictional resistance generation mechanism 7 (described hereinafter) is disposed. As described above, the frictional resistance generation mechanism 7 is disposed between the annular flat portion 27 of the disk-like plate 22 and the flywheel 21 so that the space for the frictional resistance generation mechanism 7 is considerably reduced.

The support plate 37 of the first flywheel assembly 4 is configured to support the second flywheel assembly 5 in the radial direction relative to the first flywheel assembly 4. The support plate 37 is composed of a fix portion 37a and a support portion 37b that extends to the axial-direction transmission side from the radially inner edge. The fix portion 37a is disposed between the disk-like member 13 and the tip surface of the crankshaft 2 in the axial direction. The fix portion 37a is an annular flat member and has a flat surface that extends perpendicularly to the rotational axis O-O. The fix portion 37a is received on a flat surface of the tip of the crankshaft 2. Bolt through-holes 37c are formed in the fix portion 37a in positions corresponding to the bolt through-holes 13a. According to the above-described structure, the support plate 37 is fixed to the crankshaft 2 with the bolts 15 along with the disk-like member 13 and the input disk-like plate 32.

The inner circumferential surface of the flywheel 21 is supported by an outer circumferential surface of the support portion 37b of the support plate 37 through a bush 38. As described above, the flywheel 21 is supported and centered by the support plate 37 relative to the first flywheel assembly 4 and the crankshaft 2.

The structure and function of the support plate 37 is described in detail. An inner circumferential surface 37e on the axially engine side of the support portion 37b of the support plate 37 is in contact with an outer circumferential surface 2b of an annular protrusion 2a formed on the tip of the crankshaft 2. The inner circumferential surface 37e faces the rotational axis O-O, while the outer circumferential surface 2b is arranged radially opposite the inner circumferential surface 37e. Furthermore, an inner circumferential surface of the disk-like member 13 and an inner circumferential surface of the input disk-like plate 32 is in contact with an outer circumferential surface 37f on the axially engine side of the support portion 37b. The bush 38 is preferably a radial bearing that reduces resistance in the rotational direction between the flywheel 21 and the support plate 37. In this embodiment, the bush 38 is fixed to the inner circumferential surface 21c of the flywheel 21 by fitting or adhesive. Further, the bush 38 is cylindrical member. An outer circumferential surface (cylindrical support portion) 37g on the axially transmission side of the support potion 37b is in contact with an inner circumferential surface 38b of the bush 38 so as to slide in the rotational direction. The bush 38 extends further beyond the inner circumferential surface 21c of the flywheel 21 toward the engine in the axial direction. In other words, although the axially engine side of the outer circumferential surface 38a is not in contact with the inner circumferential surface 21c of the flywheel 21, the entirety of the inner circumferential surface 38b of the bush 38 is in contact with the outer circumferential surface 37g on the axially transmission side of the support portion 37b.

By the above-mentioned support structure, the following advantages are realized.

a) The structure of the support plate 37 is simple. Specifically, the support plate 37 is composed of a single plate having the fix portion 37a and the support portion 37b extending axially from an edge of the fix portion 37a. The structure is very simple because the fix portion 37a and the support portion 37b are integral.

b) Work accuracy of the support portion 37b is improved because the support plate 37 is separate from and independent of the disk-like member 13 and the input disk-like plate 32. As a result, the accuracy of the radial positioning of the flywheel 21 is improved.

c) Assembling and disassembling of the support structure is very simple because assemblies or disassemblies of the support structure is realized just by moving the flywheel 21 with the bush 38 on or away from the inner circumferential surface 21c in the axial direction relative to the support plate 37.

Damper Mechanism

The damper mechanism 6 is described below. The damper mechanism 6 is a mechanism that elastically engages the flywheel 21 and the crankshaft 2 in the rotational direction. The damper mechanism 6 is composed of an elastic connection mechanism 29 and a frictional resistance mechanism 7 functionally disposed in parallel with the elastic connection mechanism 29 in the rotational direction.

4-1) Elastic Connection Mechanism

The elastic connection mechanism 29 is composed of a pair of output disk-like plates 30 and 31, an input disk-like plate 32, and a plurality of coil springs 33.

The pair of output disk-like plates 30 and 31 is composed of a first plate 30 on the axial-direction engine side, and a second plate 31 on the axial-direction transmission side. Both plates 30 and 31 are disk-like members, and are disposed with a certain distance therebetween in the axial direction. A plurality of window portions 30a and 31a aligned in the circumferential direction is formed in the each of plates 30 and 31. The window portions 30a and 31a are structures that support the coil spring 33 (described hereinafter) in the axial direction and in the direction of rotation, hold the coil spring 33 in the axial direction, and have upwardly cut portions that make contact at both ends in the circumferential direction thereof.

The input disk-like plate 32 is a disk-like member disposed axially between the plates 30 and 31. The input disk-like plate 32 has a plurality of window holes 32a that extends in the circumferential direction.

The coil springs 33 are made of a spring in which a large and a small spring are combined. The coil springs 33 are housed in the window holes 32a and the window portions 30a and 31a, and are supported on both sides in the radial direction and on both sides in the rotational direction. Further, the coil springs 33 are supported on both sides in the axial direction by the window portions 30a and 31a. A connection structure 34 to connect the output disk-like plate 30 and 31 with the flywheel 21 is composed of bolts 35 and nuts 36.

4-2) Frictional Resistance Generation Mechanism

The frictional resistance generation mechanism 7 is a mechanism that functions in parallel with the coil springs 33 between the output disk-like plates 30 and 31 and the input disk-like plate 32 in the direction of rotation. The frictional resistance generation mechanism 7 generates a prescribed frictional resistance (hysteresis torque) when the crankshaft 2 rotates relative to the flywheel 21. The frictional resistance generation mechanism 7 is made of a plurality of washers that contact each other. The washers are disposed in the space between the second friction surface 21b of the flywheel 21 and the annular flat portion 27 of the disk-like plate 22.

Clutch Cover Assembly

The clutch cover assembly 8 is a mechanism that is configured to bias a friction facing 54 of the clutch disk assembly 9 to the first frictional surface 21a of the flywheel 21 by an elastic force. The clutch cover assembly 8 is primarily formed of a clutch cover 48, a pressure plate 49, and a diaphragm spring 50. The clutch cover 48 is a disk-like member prepared by press working, and has a radially outer portion fixed to the radially outer portion of the flywheel 21 by bolts 51. The pressure plate 49, which is made of, e.g., cast iron, is disposed radially inside the clutch cover 48, and is axially located on the transmission side with respect to the flywheel 21 having the friction surface. The pressure plate 49 has a pressing surface 49a opposed to the first friction surface 21a of the flywheel 21. The pressure plate 49 is provided with a plurality of arc-shaped projected portions 49b projecting toward the transmission at the surface opposite to the pressing surface 49a. The pressure plate 49 is unrotatably and axially movably coupled to the clutch cover 48 by a plurality of arc-shaped strap plates 53. In the clutch engaged state, the strap plates 53 apply a load to the pressure plate 49 to bias the pressure plate 49 away from the flywheel 21.

The diaphragm spring 50 is a disk-like member disposed between the pressure plate 49 and the clutch cover 48. The diaphragm spring 50 is formed of an annular elastic portion 50a and a plurality of lever portions 50b extending radially inward from the elastic portion 50a. The radially outer portion of the elastic portion 50a is in axial contact with the end of each projected portion 49b of the pressure plate 49 on the transmission side.

The clutch cover 48 is provided with a plurality of tabs 48a at its inner periphery, which extend axially toward the engine and are bent radially outward. Each tab 48a extends through an aperture in the diaphragm spring 50 toward the pressure plate 49. The tabs 48a support two wire rings 52, which support axially opposite sides of the radially inner portion of the elastic portion 50a of the diaphragm spring 50. In this state, the elastic portion 50a is axially compressed to apply an axial force to the pressure plate 49 and the clutch cover 48.

Clutch Disk Assembly

The clutch disk assembly 9 has the friction facing 54 disposed between the first friction surface 21a of the flywheel 21 and the pressing surface 49a of the pressure plate 49. The friction facing 54 is fixed to a hub 56 via a circular and annular plate 55. The hub 56 has a central aperture spline-engaged with the transmission input shaft 3.

Release Device

The release device 10 is a mechanism provided to drive the diaphragm spring 50 of the clutch cover assembly 8 to perform the clutch releasing operation on the clutch disk assembly 9. The release device 10 is primarily formed of a release bearing 58 and a hydraulic cylinder device (not shown). The release bearing 58 is primarily formed of inner and outer races as well as a plurality of rolling elements arranged therebetween and can bear radial and thrust loads. A cylindrical retainer 59 is attached to the outer race of the release bearing 58. The retainer 59 has a cylindrical portion, a first flange, and a second flange. The cylindrical portion contacts the outer peripheral surface of the outer race. The first flange extends radially inward from an axial end on the engine side of the cylindrical portion and is in contact with the surface on the transmission side of the outer race in the axial direction. The second flange extends radially outward from an end on the engine side of the cylindrical portion in the axial direction. The second flange is provided with an annular support portion, which is in axial contact with a portion on the engine side of the radially inner end of each lever portion 50b of the diaphragm spring 50.

A hydraulic cylinder device is primarily formed of a hydraulic chamber forming member and a piston 60. The hydraulic chamber forming member and the cylindrical piston 60 arranged radially inside the member define a hydraulic chamber between them. The hydraulic chamber can be supplied with a hydraulic pressure from a hydraulic circuit. The piston 60 has a substantially cylindrical form and has a flange which is in axial contact with a portion on the transmission side of the inner race of the release bearing 58. When the hydraulic circuit supplies a hydraulic fluid into the hydraulic chamber, the piston 60 axially moves the release bearing 58 toward the engine.

Operation

Torque Transmission

In this clutch device 1, the torque from the engine crankshaft 2 is input to the flywheel damper 11, and is transmitted from the first flywheel assembly 4 to the second flywheel assembly 5 by way of the damper mechanism 6. In this damper mechanism 6, the torque is transmitted in order from the input disk-like plate 32, the coil springs 33, and the output disk-like plates 30 and 31. In addition, the torque is transmitted from the flywheel damper 11 to the clutch disk assembly 9 with the clutch in an engagement state, and is finally output to the input shaft 3.

Absorption and Attenuation of Torsional Vibrations

When a combustion fluctuation from the engine is input to flywheel damper 11, the output disk-like plates 30 and 31 rotate relative to the input disk-like plate 32 in the damper mechanism 6, and the coil springs 33, of which there are preferably four, are compressed in parallel therebetween. In addition, the frictional resistance generation mechanism 7 generates a prescribed hysteresis torque. The torsional vibration is absorbed and attenuated by the above-described operation. The compression of the coil springs 33 is specifically carried out between the end face in the rotational direction of the window portions 30a and 31a of the output disk-like plates 30 and 31, and an end face in the rotational direction of the window hole 32a of the input disk-like plate 32.

When the torsional vibration is input, the inner circumferential surface 21c of the flywheel 21 slides relative to the outer circumferential surface 37g of the support portion 37b of the support plate 37 by way of the bush 38 in the rotational direction. Thus, the bush 38 reduces resistance in the rotational direction.

### Alternate Embodiments

Alternate embodiments will now be explained. In view of the similarity between the first and the alternate embodiments, the parts of the alternate embodiments that are identical to the parts of the first embodiment will be given the same reference numerals as the parts of the first embodiment. Moreover, the descriptions of the parts of the alternate embodiments that are identical to the parts of the first embodiment may be omitted for the sake of brevity.

### 2. Second Embodiment (1) Structure

Overall Structure

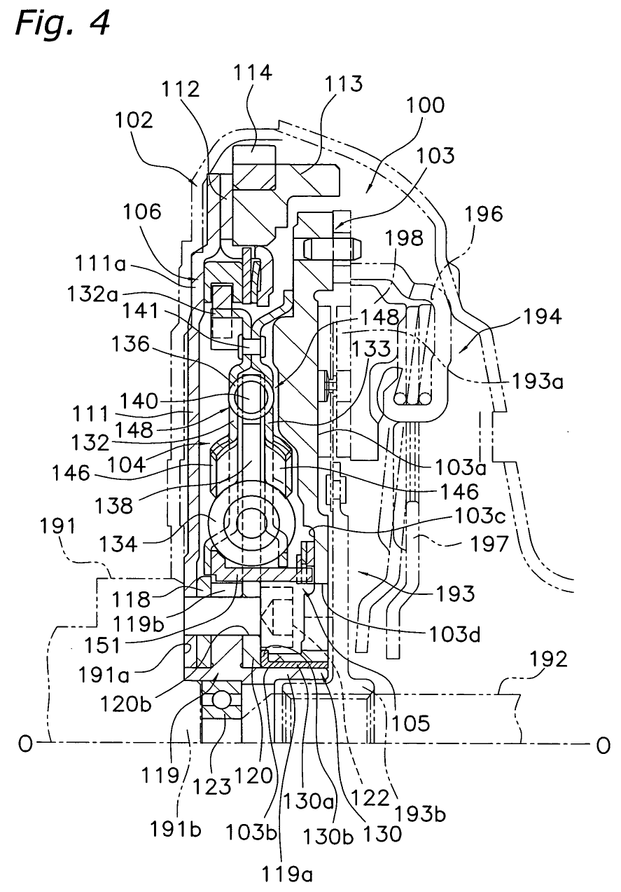

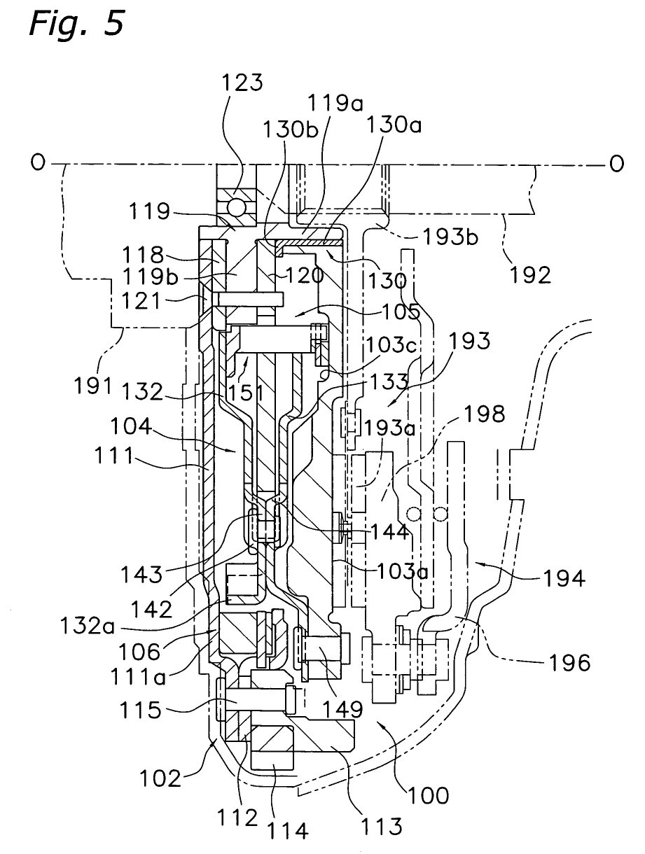

As seen in FIGS. 4 and 5, a double mass flywheel or flywheel damper 101 in accordance with a second preferred embodiment of the present invention is provided to transmit torque from a crankshaft 191 on an engine side to an input shaft 192 on an transmission side by way of a clutch including a clutch disk assembly 193 and a clutch cover assembly 194. The double mass flywheel 101 has a damper function to absorb and attenuate torsional vibration. The double mass flywheel 101 is mainly made of a first flywheel 102, a second flywheel 103, a damper mechanism 104, a first friction generation mechanism 105, and a second friction generation mechanism 106.

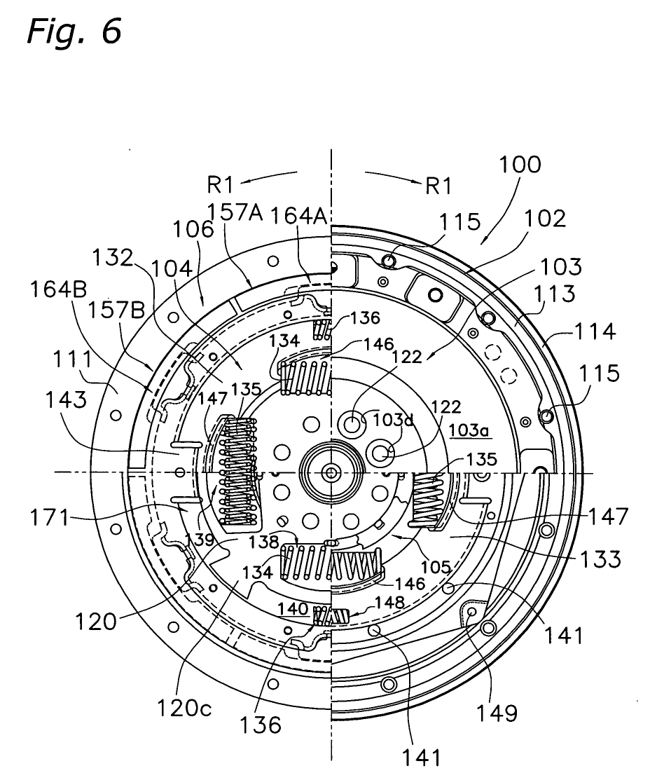

In FIGS. 4 and 5, O-O indicates a rotation axis of the double mass flywheel 101 and the clutch. An engine (not shown) is disposed on the left side in FIGS. 4 and 5, and a transmission (not shown) is disposed on the right side. In following description, the left side in FIGS. 1 and 2 will be referred to as the engine side, which is based on the axial direction, and the right side will be referred to the transmission side, which is also based on the axial direction. In FIG. 6, an arrow R1 indicates a drive side, i.e., forward side in the rotational direction, and an arrow R2 indicates a reverse drive side (rearward side in the rotational direction). The numerical values in the following embodiments are shown as examples and do not limit the present invention.

First Flywheel

The first flywheel 102 is fixed to the tip of the crankshaft 191. The first flywheel 102 ensures a large moment of inertia on the crankshaft side. The first flywheel 102 principally includes a flexible plate 111 and an inertia member 113. The flexible plate 111 is provided to absorb bending vibrations from the crankshaft 191 as well as to transmit torque from the crankshaft 191 to the inertia member 113. Accordingly, the flexible plate 111 has a high rigidity in the rotational direction but a relatively low rigidity in the axial and bending directions. Specifically, the axial rigidity of the flexible plate 111 is equal to or below 3000 kg/mm, preferably in the range between 600 kg/mm and 2200 kg/mm. The flexible plate 111 is a disk-like plate having a central hole and made of a metal plate, for example. The radially inner end of the flexible plate 111 is fixed to the tip of the crankshaft 191 by a plurality of bolts (fix members) 122. Bolt through-holes are formed in the flexible plate 111 in positions corresponding to the bolts 122. The bolts 122 are mounted on the crankshaft 191 from the axial-direction transmission side.

The inertia member 113 is a member with a thick block shape when viewed cross-sectionally, and is fixed to the axial-direction transmission side on the radially outer edge of the flexible plate 111. The radially outer portion of the flexible plate 111 is fixed to the inertia member 113 by a plurality of rivets 115 aligned circumferentially. A ring gear 114 that is provided to facilitate engine startup is fixed to the outer circumferential surface of the inertia member 113. The first flywheel 102 may also be constructed as an integral member.

Second Flywheel

The second flywheel 103 is an annular disk-like member, and is disposed on the axial-direction transmission side of the first flywheel 102. The second flywheel 103 has a friction surface 103a formed on the axial-direction transmission side. The friction surface 103a is an annular, flat surface. Further, the friction surface 103a is a portion that engages a clutch disk assembly 193 described hereinafter. The second flywheel 103 has an inner cylindrical portion 103b extending toward the engine in the axial direction from the inner circumferential edge. A radially inner portion of the second flywheel 103 is formed with a plurality of through holes 103d aligned in the circumferential direction with the bolts 122, such that the bolts 122 can pass therethrough.

Damper Mechanism

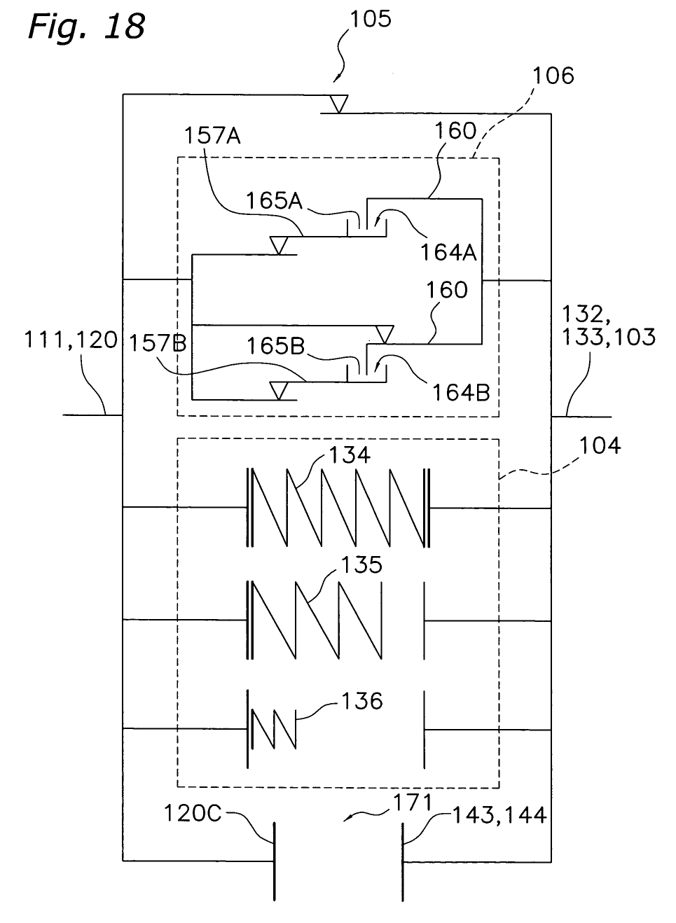

The damper mechanism 104 is described below. The damper mechanism 104 elastically engages the second flywheel 103 and the crankshaft 191 in the rotational direction. Therefore, the second flywheel 103 with the damper mechanism 104 constitutes a flywheel assembly or a flywheel damper because the second flywheel 103 is connected to the crankshaft 191 by way of the damper mechanism 104. As shown in FIG. 6, the damper mechanism 104 is composed of a plurality of coil springs 134, 135, and 136, a pair of output disk-like plates 132 and 133, and an input disk-like plate 120. As shown in the mechanical circuit of FIG. 18, the coil springs 134, 135, and 136 are located functionally in parallel with the first and second friction generation mechanism 105 and 106 in the rotational direction.

Referring again to FIGS. 4 and 5, the pair of output disk-like plates 132 and 133 is composed of a first plate 132 on the axial-direction engine side, and a second plate 133 on the axial-direction transmission side. Both plates 132 and 133 are disk-like members, and are disposed with a certain distance therebetween in the axial direction. A plurality of window portions 146 and 147 aligned in the circumferential direction are respectively formed in each of the plates 132 and 133. The window portions 146 and 147 are structures that support the coil springs 134 and 135 (described hereinafter) in the axial and rotational directions, hold the coil springs 134 and 135 in the axial direction, and have upwardly cut portions that make contact at both ends in the circumferential direction thereof. As seen in FIG. 6, the number of the window portions 146 and 147 is preferably two, respectively, for a total of four. The window portions 146 and 147 are aligned alternately in the circumferential direction in the same radial position. Furthermore, the plates 132 and 133 are formed with a plurality of third window portions 148 aligned in the circumferential direction. The number of the third window portions 148 is preferably two. The third window portions 148 are opposed to each other in a radial direction. Specifically, the third window portions 148 are formed radially outward of the first window portions 146 and support the third coil springs 136 described hereinafter in the axial and rotational direction.

As seen in FIGS. 4 and 5, the first plate 132 and the second plate 133 maintain a distance in the axial direction at the radially inner portions, but are in contact with each other at the radially outer portions and fixed to each other by rivets 141 and 142. As seen in FIG. 6, the first rivets 141 are aligned in the circumferential direction. As seen in FIGS. 5 and 6, the second rivets 142 are disposed at cut and raised contact portions 143 and 144 of the first plate 132 and the second plate 133 respectively. The contact portions 143 and 144 are formed in two positions diametrically opposing each other. Specifically, the contact portions 143 and 144 are formed radially outward of the second window portion 147. As shown in FIG. 5, axial position of the contact portions 143 and 144 is the same as that of the input disk-like plate 120.

As seen in FIGS. 5 and 6, the second plate 133 is fixed to the second flywheel 103 through rivets 149 at each of the radially outer portions.

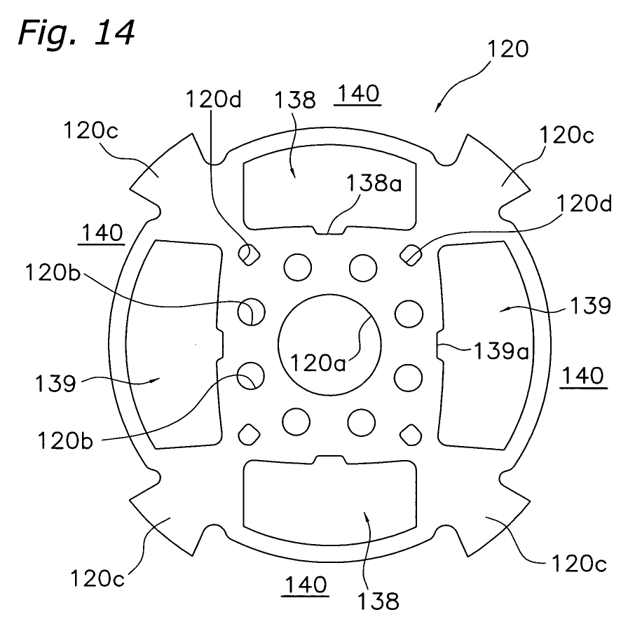

Referring now to FIGS. 4, 5 and 6, the input disk-like plate 120 is a disk-like member disposed between the plates 132 and 133. The input disk-like plate 120 has a plurality of first window holes 138 corresponding to the window portions 146, and second window holes 139 corresponding to the first window portions 147. As seen in FIG. 14, the first and second window holes 138 and 139 have a straight or slightly curved radially inner edge having a recess 138a and 139a extending radially inward at the circumferentially middle portion. The input disk-like plate 120 is formed with a central hole 120a and a plurality of through holes 120b for bolts to be inserted around the central hole 120a. The input disk-like plate 120 has a plurality of protrusions 120c extending radially outward from the radially outer edge at the locations circumferentially between the window holes 138 and 139. As seen in FIG. 6, the protrusions 120c are positioned circumferentially apart from the contact portions 143 and 144 of the output disk-like plates 132 and 133 and the third coil springs 136 such that the protrusion 120c can collide with either of them in the circumferential direction. In other words, the protrusions 120c and the contact portions 143 and 144 constitute a stopper mechanism 171 of the damper mechanism 104. Furthermore, spaces between the protrusions 120c in the circumferential direction function as third window holes 140 for accommodating the third coil springs 136. Referring again to FIG. 14, in addition, the input disk-like plate 120 is formed with a plurality of holes 120d. The number of holes 22d is preferably four. Each hole 120d has a shape of a circle longwise in the radial direction. The rotational positions of the holes 120d are between the window holes 138 and 139 in the circumferential direction, and the radial position of the holes 120d are the same as or close to those of the recesses 138a

As mentioned above, the protrusions 120c of the input disk-like plate 120 function as partitions maintaining space therebetween in the circumferential direction. Between each of protrusions 120c the third spring 136 or the contact portion 143 and 144 is disposed. In other words, the protrusions 120c have a function of abutting with the third coil springs 136 in the rotational direction and a function of abutting with the contact portions 143 and 144 of the disk-like plates 132 and 133 in the rotational direction.

Referring again to FIGS. 4 and 5, the input disk-like plate 120 is fixed to the crankshaft 191 together with the flexible plate 111, a reinforcement member 118, and a support member 119. The radially inner portion of the flexible plate 111 is in contact with an axially transmission side surface of a tip surface 191a of the crankshaft 191. The reinforcement member 118 is a disk-like member and is in contact with an axially transmission side surface of the radially inner portion of the flexible plate 111.

The support member 119 is composed of a disk-like portion 119b and a cylindrical portion 119a that extends to the axial-direction transmission side from the radially outer edge. The disk-like portion 119b is in contact with an axially transmission side surface of the reinforcement member 118. The disk-like portion 119b is formed with through holes for bolts 122 and is fixed to the crankshaft 191. The disk-like portion 119b is an annular flat portion and the cylindrical portion 119a extends toward the transmission in the axial direction from a radially inner edge. The inner circumferential surface of the cylindrical portion 119a is in contact with the outer circumferential surface of a cylindrical projection 191b formed at the center of the tip of the crankshaft 191 so that the support member 119 is centered in the radial direction. The inner circumferential surface of the input disk-like plate 120 is in contact with the outer circumferential surface of a cylindrical portion 119a at an axially transmission side portion so that the input disk-like plate 120 is centered in the radial direction. A bearing 123 is attached to the inner circumferential surface of the cylindrical portion 119a to support the tip of the input shaft 192 of the transmission. In addition, the members 111, 118, 119, and 120 are fastened to each other by screws 121.

As described above, the support member 119 is fixed to the crankshaft 191 such that the support member 119 is centered relative to the crankshaft. Further, the support member 119 centers the first flywheel 102 and the second flywheel 103 in the radial direction. That is, the one member has a plurality of functions so that the number of the components is reduced and manufacturing costs are reduced.

The inner circumferential surface of the cylindrical portion 103b of the second flywheel 103 is supported by an outer circumferential surface of the cylindrical portion 119a of the support portion 119 through a bush 130. As described above, the second flywheel 103 is supported and centered by the support member 119 relative to the first flywheel 102 and the crankshaft 2. The bush 130 further has a radial bearing portion 130a already described and a thrust bearing portion 130b disposed between the radially inner portion of the input disk-like plate 120 and a tip of the cylindrical portion 103b of the second flywheel 103. As a result, a thrust load from the second flywheel 103 is received by the members 111, 118, 119, and 120, which are aligned in the axial direction through the thrust bearing portion 130b. In other words, the thrust bearing portion 130b of the bush 130 functions as a thrust bearing supported by the radially inner portion of the input disk-like plate 120 for an axial load from the second flywheel 103. The load generated at the thrust bearing portion 130b is stable because the radially inner portion of the input disk-like plate 120 is flat and the flatness is improved. Furthermore, the length of the thrust bearing portion 130b is long enough to stabilize hysteresis torque because the radially inner portion of the input disk-like plate 120 is flat. Furthermore, the radially inner portion of the input disk-like plate 120 is unlikely to be deformed since it is in direct contact with the disk-like portion 119b of the support member 119 such that there is no space in the axial direction.

The radial bearing portion and the thrust bearing portion may be separate members. In addition, the input disk-like plate 120 may directly contact the tip surface of the crankshaft 191.

The first coil spring 134 is disposed in the first window holes 138 and the first window portions 146. Rotational ends of the first coil spring 134 are in contact with or close to rotational end surfaces of the first window holes 138 and the first window portion 146.

As shown in FIG. 6, the second coil springs 135 are disposed in the second window holes 139 and the second window portions 147. The second coil spring 135 is made of a large and a small spring. Thus, the second coil spring 135 has a higher rigidity than the first coil spring 134. Rotational ends of the second coil spring 135 are in contact with or close to rotational end surfaces of the second window portion 147 but is separated in the circumferential direction from rotational end surfaces of the second window hole 139 by a certain angle, which is preferably four degrees in this embodiment. Referring now to FIGS. 4, 5, and 6, the first coil springs 134 and the second coil springs 135 are aligned in the circumferential direction, wherein the radial positions are the same. The first coil springs 134 and the second coil springs 135 are disposed radially inward of a portion of the clutch friction surface 103a against which the friction facing 193a is pressed, i. e., the springs 134 and 135 do not have any portion which is positioned radially outward of the inner circumferential edge of the clutch engagement portion. Accordingly, the axial dimension of the flywheel assembly is reduced because the first and second coil springs 134 and 135 are located radially inward of the clutch friction surface 103a of the second flywheel 103.

The third coil springs 136 are disposed in the third window holes 140 and the third window portions 148. The third coil springs 136 are smaller than the second and third coil springs 134 and 135. Further, the rigidity of the third coil springs 136 is higher than that of the first and second coil springs 134 and 135, and preferably at least twice as rigid. The third coil springs 136 are functionally disposed between the second flywheel 103 and the crankshaft 191 are functionally disposed in parallel with the first and second coil springs 134 and 135 in the rotational direction. The radial position of the third coil springs 136 is within an annular area defined by the friction surface 103a.

Friction Generation Mechanism

5-1) First Friction Generation Mechanism

The first friction generation mechanism 105 operates between the input disk-like plate 120 and the output disk-like plate 132 and 133 of the damper mechanism 104 in parallel with the coil springs 134, 135, and 136 in the rotational direction. The first friction generation mechanism 105 generates a certain frictional resistance (hysteresis torque) when the second flywheel 103 rotates relative to the crankshaft 191. The first generation mechanism 105 generates friction over the entire torsional angle region and is not excessively high.

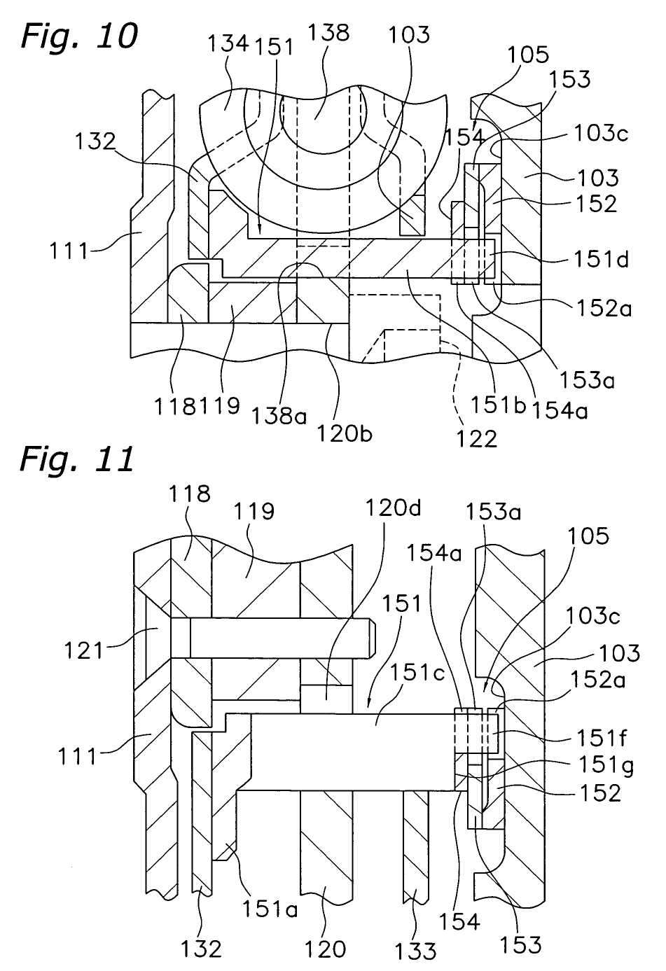

The first friction generation mechanism 105 is disposed radially inward of the damper mechanism 104 and axially between the first plate 132 and the second flywheel 103. As seen in FIG. 10, the first friction generation mechanism 105 is composed of a first friction member 151, a second friction member 152, a cone spring 153, and a washer 154.

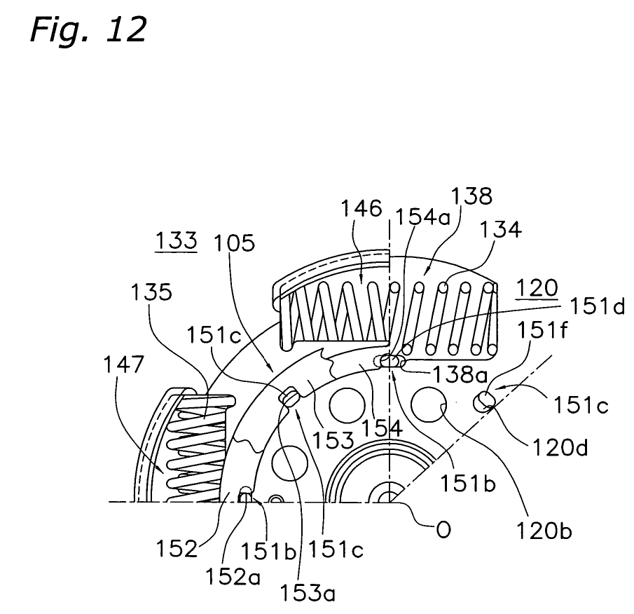

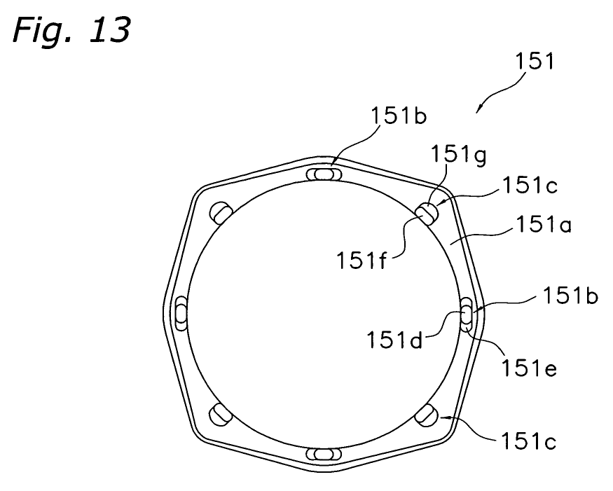

The first friction member 151 rotates together with the input disk-like plate 120 to slide against the first plate 132 in the rotational direction. As shown in FIGS. 10-13, the first friction member 151 has an annular portion 151a, and first and second engagement portions 151b and 151c extending from the annular portion 151a. The annular portion 151a contacts the radially inner portion of the first plate 132 to slide in the rotational direction. The first engagement portions 151b and the second engagement portions 151c are located alternately in the circumferential direction. The first engagement portion 151b has a shape extending in the circumferential direction with narrow width in the radial direction. In other words, the first engagement portion 157b is slot-shaped. The first engagement portion 147b is engaged with the recesses 138a and 139a of the window holes 138 and 139 of the input disk-like plate 120. The second engagement portion 151c has a shape of extending in the radial direction but not to the extent of the first engagement portion 151b. The second engagement portion 151c is engaged with the hole 120d of the input disk-like plate 120. Accordingly, the first friction member 151 can move relative to the input disk-like plate 120 in the axial direction, but not in the rotational direction.

A first protrusion 51d is formed at the circumferentially middle position of the tip of the first engagement portion 151b and extends in the axial direction from the first engagement portion 151b. A pair of first axial end surfaces 151e is formed on the circumferential sides of the first protrusion 151d. Furthermore, a second protrusion 151f is formed at the radially inward portion of the tip of the second engagement portion 151c. A first axial end surface 151g is formed radially outward of the second protrusion 151f.

The second friction member 152 rotates together with the input disk-like plate 120 to slide against the second flywheel 103 in the rotational direction. As shown in FIGS. 4, 10, 11, and 17, the second friction member 152 is an annular member and contacts a second friction surface 103c, which is in the radially inner portion of the second flywheel 103. The second friction surface 103c is a concave portion that extends toward the transmission in the axial direction further than any other portion on the engine side of the second flywheel 103, and is an annular flat surface.

The second friction member 152 is formed with a plurality of recesses 152a aligned in the circumferential direction at the inner circumferential edge. The first protrusion 151d of the first engagement portion 151b and the second protrusion 151f of the second engagement portion 151c are respectively engaged with the recesses 152a. Accordingly, the second friction member 152 can move relative to the first friction member 151 in the axial direction, but not in the rotational direction.

The cone spring 153 is disposed axially between the first friction member 151 and the second friction member 152 and urges each of the members in axially opposite directions. As shown in FIG. 16, the cone spring 153 is a conical or disk-like member formed with a plurality of recesses 153a at the inner circumferential edge. Referring now to FIGS. 10, 11, and 16, the fist protrusion 151d of the first engagement portion 151b and the second protrusion 151f of the second engagement portion 151c are respectively engaged with the recesses 153a. Accordingly, the cone spring 153 can move relative to the first friction member 151 in the axial direction, but not in the rotational direction.

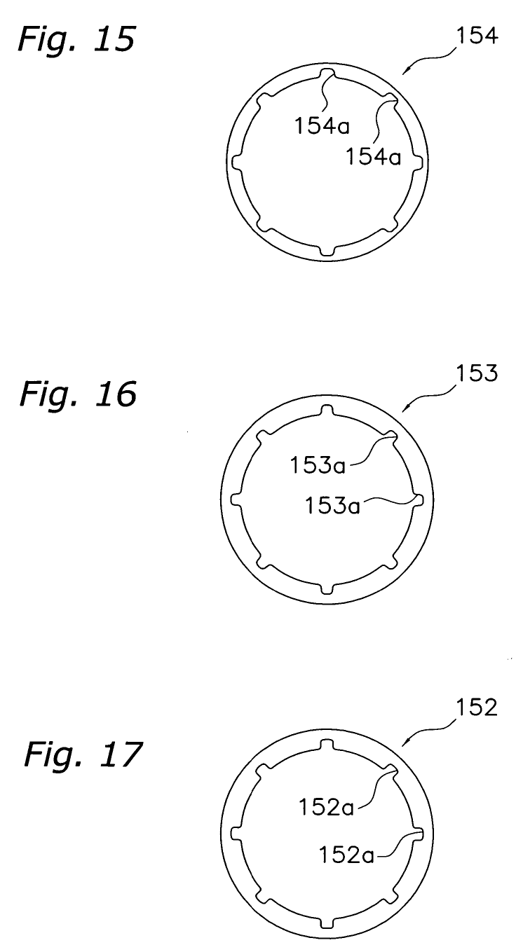

The washer 154 is provided to ensure or stabilize the transfer of a load of the cone spring 153 to the first friction member 151. As shown in FIG. 15, the washer 154 is an annular member and is formed with a plurality of recesses 154a aligned in the circumferential direction at the radially inner edge. Referring now to FIGS. 10, 11, and 15, the first protrusion 151d of the first engagement portion 151b and the second protrusion 151f of the second engagement portion 151c are respectively engaged with the recesses 154a. Accordingly, the washer 154 can move relative to the first friction member 151 in the axial direction, but not in the rotational direction. Referring now to FIGS. 10, 11, 13, and 15, the washer 154 is received on the first axial end surface 151e of the first engagement portion 151b and the second axial end surface 151g of the second engagement portion 151c. The radially inner portion of the cone spring 153 is supported by the washer 154 and the radially outer portion of the cone spring 153 is supported by the second friction member 152.

5-2) Second Friction Generation Mechanism

Referring now to FIGS. 4 and 5, the second friction generation mechanism 106 operates between the input disk-like plate 120 and the output disk-like plate 132 and 133 of the damper mechanism 104 in parallel with the coil springs 134, 135, and 136. The second friction generation mechanism 106 generate a relatively large frictional resistance (hysteresis torque) over the whole range of the torsional characteristics when the second flywheel 103 rotates relative to the crankshaft 191. In this embodiment, the hysteresis torque generated by the second friction generation mechanism 106 is from five to ten times that generated by the first friction generation mechanism 105.

The second friction generation mechanism 106 is made of a plurality of washers contacting with each other disposed in an axial space between an annular portion 111a at the radially outer portion of the flexible plate 111 and a second disk-like plate 112 disposed axially between the flexible plate 111 and the inertia member 113. The washers of the second friction generation mechanism 106 are disposed adjacent to a radially inward side of the inertia member 113 and the rivets 115.

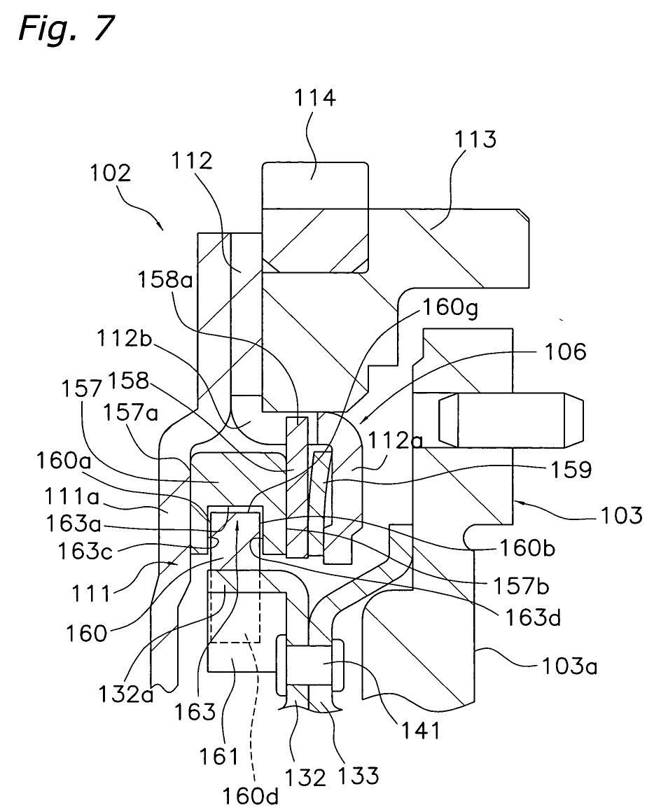

As seen in FIG. 7, the second friction generation mechanism 106 has, in order in an axial direction from the flexible plate 111 toward the opposing portion 112a of the second disk-like plate 112, friction washers 157, an input friction plate 158, and a cone spring 159. Thus, the flexible plate 111 has a function that accommodates the second friction generation mechanism so the number of components is reduced and the structure simplified.

The cone spring 159 imparts a load in the axial direction to friction surfaces. Further, the cone spring 159 is interposed and compressed between the opposing portion 112a and the input friction plate 158, and therefore exerts an urging force on both members in the axial direction. Pawls 158a formed on the radially outer edge of the input friction plate 158 are engaged with axially extending cutaway areas 112b of the second disk-like plate 112. Thus, the input friction plate 158 is prevented from rotating relative to the second disk-like plate 112 by this engagement, but is movable in the axial direction.

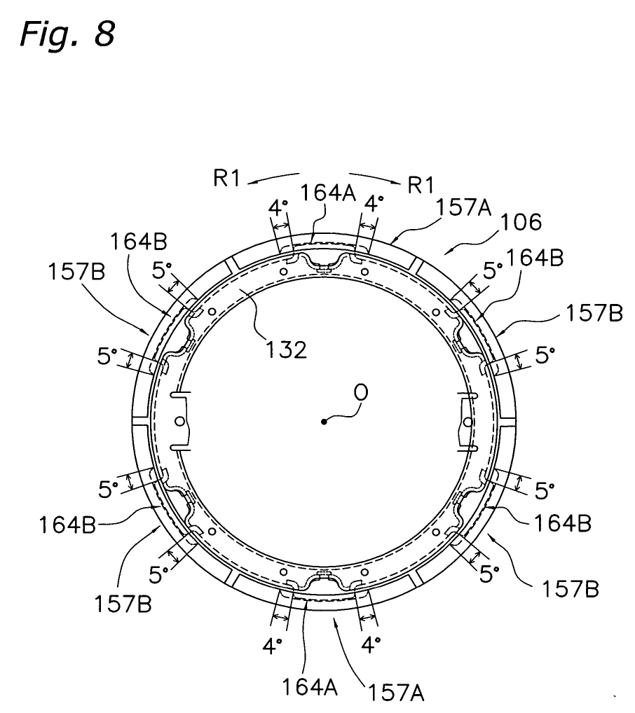

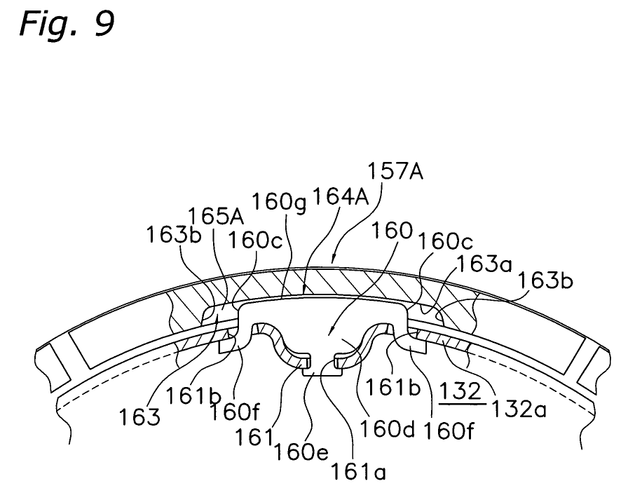

As seen in FIG. 8, the friction washers 157 are composed of a plurality of members. The members are aligned and disposed in the direction of rotation, and each of these extends in the form of an arc. In this embodiment, there are preferably a total of six friction washers 157. Referring again to FIG. 7, the friction washers 157 are interposed between the input friction plate 158 and the annular portion 111a of the flexible plate 111. In other words, the axial-direction engine side surface 157a of the friction washers 157 makes contact in a slidable manner with the axial-direction transmission side surface of the flexible plate 111, and the axial-direction transmission side surface 157b of the friction washers 157 makes contact in a slidable manner with the axial-direction engine side surface of the input friction plate 158. Referring now to FIGS. 7 and 9, concavities 163 are axially and rotationally formed in the inner circumferential surface of the friction washers 157. The concavities 163 are formed roughly in the center of the direction of rotation of the friction washers 157, and more specifically, have a bottom surface 163a extending in the direction of rotation, and rotational direction end faces 163b extending from both ends thereof in a roughly radial direction (roughly at a right angle from the bottom surface 163a). In other words, the concavities open toward the axis of rotation O-O, with the bottom surface 163a being arranged radially outward of its opening, and the rotational direction end faces 163b extending radialy inward from the bottom surface 163a. The concavity 163 is formed in the axially middle portion of the inner circumferential surface of the friction washer 157 so that the concavity 163 has axial end faces 163c and 163d forming axial side surfaces.

A plurality of friction engagement members 160 is disposed to correspond to the concavities 163 of the friction washers 157. More specifically, the friction engagement members 160 are disposed radially inward of the friction washers 157 and within the concavities 163. The radially outer portion of the friction engagement member 160 is within the concavity 163. Both the friction washers 157 and friction engagement members 160 are preferably made of resin.

A friction engagement portion 164 including the friction engagement members 160 and the concavities 163 of the friction washer 157 is described below. The friction engagement members 160 have axial end faces 160a and 160b and rotational end faces 160c. An outer circumferential surface 160g of the friction engagement member 160 is adjacent to the bottom surface 163a of the concavities 163. Further, a rotational direction gap 165 with a prescribed angle is defined between each of the rotational end faces 160c and the rotational direction end faces 163b. The total of both angles is a prescribed angle whose size allows the friction washer 157 thereof to rotate relative to the friction engagement members 160. This angle is preferably within a range that is equal to or slightly exceeds the damper operation angle created by small torsional vibrations caused by combustion fluctuations in the engine. In this embodiment, the friction engagement members 160 are disposed in the center of the direction of rotation of the concavities 163 in the neutral state shown in FIG. 9. Therefore, the size of the gap is the same on either side in the direction of rotation of the friction engagement members 160.

The friction engagement members 160 are engaged with the first plate 132 to rotate together with the first plate 132 and be movable in the axial direction. More specifically, an annular wall 132a extending toward the engine in the axial direction is formed on the radially outer edge of the first plate 132, and concavities 161 indented on the internal side in the radial direction are formed corresponding to each friction engagement member 160 on the annular wall 132a. In addition, a first slit 161a penetrating in the radial direction at the rotational center of the concavity 161 and second slits 161b penetrating in the radial direction are formed on both sides in the direction of rotation. The friction engagement members 160 have a first leg 160e extending through the first slit 161a radially inward. Furthermore, the friction engagement members 160 also have second legs 160f that extend in both rotational directions which are in contact with the inner circumferential surface of the annular wall 132a. The second legs 160f extend through the second slits 161b radially inward and extending outward in the direction of rotation. Moreover, the second legs 106f make contact with the inner circumferential surface of the annular wall 132a. As a result, the friction engagement members 160 do not move outwardly from the annular wall 132a in the radial direction. In addition, the friction engagement members 160 have convexities 160d that extend inward in the radial direction, and is engaged in the direction of rotation with the concavities 161 in the annular wall 132a. The friction engagement members 160 are thereby integrally rotated as convexities of the first plate 132. In addition, the friction engagement member 160 can be attached to and detached from the first plate 132 in the axial direction.

The friction engagement member 160 can move relative to the friction washer 157 because the axial length of the friction engagement member 160 is shorter than the axial length of the concavity 163, that is, the distance between the axial end faces 163c and 163d is longer than the axial length of the axial end faces 160a and 160b of the friction engagement member 160. Further, the friction engagement member 160 can also tilt relative to the friction washer 157 to a certain angle because a radial space is ensured between the outer circumferential surface 160g of the friction engagement member 160 and the bottom surface 163a of the concavity 163.

As described above, the friction washer 157 is frictionally engaged with the flexible plate 111 and the input friction plate 158 in a manner that allows movement in the direction of rotation, and is engaged in a manner that allows torque to be transmitted to the friction engagement members 160 by way of the rotational direction gap 165 in the engagement portion 164. The friction engagement members 160 can also integrally rotate with the first plate 132, and move relatively in the axial direction.

Next, referring to FIGS. 7-9, the relationship between the friction washer 157 and the friction engagement members 160 is described in greater detail. The widths in the direction of rotation (the angles in the direction of rotation) of the friction engagement members 160 are all the same, but some of the widths in the direction of rotation (the angles in the direction of rotation) of the concavities 163 are different. That is to say, there are at least two types of friction washers 157 having concavities 163 with differing widths in the rotation direction. In this embodiment, the friction washers 157 are made of first and second friction washers 157A and 157B. Two first friction washers 157A face each other in the up and down directions in FIG. 8, and four second friction washers 157B that face each other in the left and right directions. The first friction washers 157A and concavities 163, and the second friction washers 157B and concavities 163 respectively form first and second engagement portions 164A and 164B. The first friction washers 157A and the second friction washers 157B have roughly the same shape, and are made of the same material. The only major point in which the first and second friction washers 157A and 157B differ is the length in the direction of rotation (the angles in the direction of rotation) of the rotational direction gap of the concavities 163. More specifically, the length in the direction of rotation of the concavities 163 of the second friction washers 157B is larger than the length in the direction of rotation of the concavities 163 of the first friction washers 157A. As a result, the first friction washers 157A concavities 163 and the friction engagement members 160 have first rotational direction gaps 165A, while concavities 163 of the second friction washers 157B and the friction engagement members 160 have second rotational direction gaps 165B. Further, the second rotational direction gap 165B of the second engagement portion 164B in the second friction washers 157B is larger than the first rotational direction gap 165A of the first engagement portion 164A in the first friction washers 157A. In this embodiment, the former is preferably 10° and the latter is preferably 8°, for a difference of 2°, for example.

The first and second friction washers 157A and 157B are disposed and aligned in the direction of rotation, and both edges thereof in the direction of rotation are adjacent to each other. The first and second friction washers 157A and 157B are arranged to alternate between one first friction washer 157A for every two second friction washers 157B in the rotation direction. The angle between the edges of the washers 157A and 157B in the direction of rotation is set to a value that is greater than the difference (2°, for example) between the second rotational direction gap 165B in the second friction washers 157B and the first rotational direction gap 165A in first friction washers 157A.

Clutch Disk Assembly

Referring now to FIGS. 4 and 5, the clutch disk assembly 193 has a friction facing 193a disposed axially between the first friction surface 103a of the second flywheel 103 and a pressure plate 198. Further, the clutch disk assembly has a hub 193b spline-engaged with the transmission input shaft 192.

Clutch Cover Assembly

The clutch cover assembly 194 is primarily formed of a clutch cover 196, a diaphragm spring 197, and the pressure plate 198. The clutch cover 196 is an annular disk-like member fixed to the second flywheel 103. The pressure plate 198 is an annular member having a pressing surface adjacent to the friction facing 193a and rotates together with the clutch cover 196. The diaphragm spring 197 is supported by the clutch cover 196 to urge elastically the pressure plate 198 toward the second flywheel 103. When a release device not shown pushes the radially inner end of the diaphragm spring 197 toward the engine, the diaphragm spring 197 releases the load axially placed on the pressure plate 198.

Operation

Torque Transmission

Referring to FIGS. 4-6, in this double mass flywheel 101, a torque supplied from the crankshaft 191 of the engine is transmitted to the second flywheel 103 via the damper mechanism 104. In the damper mechanism 104, the torque is transmitted through the input disk-like plate 120, coil springs 134-136, and output disk-like plates 132 and 133 in this order. Further, the torque is transmitted from the double mass flywheel 101 to the clutch disk assembly 193 in the clutch engaged state and is finally provided to the input shaft 192.

Absorption and Attenuation of Torsional Vibrations

When the double mass flywheel 101 receives combustion variations from the engine, the damper mechanism 104 operates to rotate the input disk-like plate 120 relatively to the output disk-like plates 132 and 133 so that the coil springs 134-136 are compressed in parallel in the rotational direction. Further, the first friction generation mechanism 105 and the second friction generation mechanism 106 generate a predetermined hysteresis torque. Through the foregoing operations, the torsional vibrations are absorbed and damped.

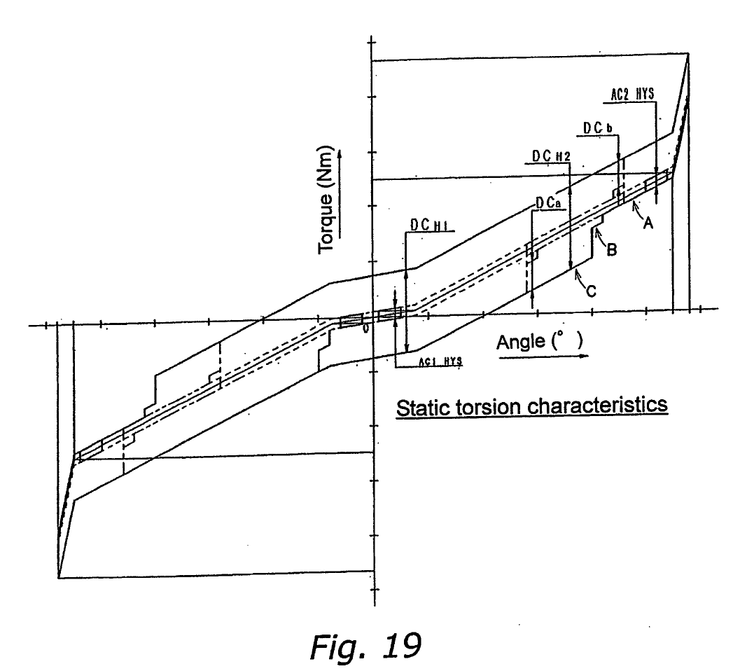

Next, the operation of the damper mechanism 104 is described referring to FIG. 18 and to the torsional characteristics of FIG. 19. In a small torsional angle area around zero degrees, only the first coil springs 134 are compressed to achieve relatively low rigidity. As the torsional angle becomes larger, the first coil springs 134 and the second coil spring 135 are compressed in parallel to achieve relatively high rigidity. As the torsional angle becomes even larger, the first coil springs 134, the second coil springs 135 and the third coil springs 136 are compressed in parallel to achieve the highest rigidity allowed at the ends of the torsional characteristics. The first friction generation mechanism 105 operates over the entire torsional angle range. The second friction generation mechanism 106 does not operate within certain angles on either side of the torsional angle after the direction of the torsional action changes.

Next, referring to FIGS. 7-9, and 18, the operation performed when the friction washer 157 is driven by the friction engagement member 160 is described. The operation in which the friction engagement member 160 is twisted from the neutral state in the rotation direction R1 in relation to the friction washer 157 is described.

When the torsion angle increases, the first friction engagement member 160 in the first friction washers 157A eventually make contact with the rotational direction end face 163b on the rotational direction R1 side of the concavities 163 of the first friction washers 157A. At this time, the friction engagement member 160 in the second friction washers 157B have a rotational direction gap (which is half the difference between the second rotation direction gap 165B of the second friction washers 157B and the first rotational direction gap 165A of the first friction washers 157A, and is 1° in this embodiment) in the rotational direction end face 163b of the concavities 163 of the second friction washers 157B in the rotational direction R1.

When the torsion angle further increases, the friction engagement member 160 drives the first friction washers 157A, and causes them to slide in relation to the flexible plate 111 and the input friction plate 158. At this time, the first friction washers 157A approach the second friction washers 157B in the rotational direction R1, but the edge portions of both of these do not make contact.

When the torsion angle finally achieves a prescribed magnitude, the friction engagement members 160 make contact with the rotational direction end face 163b of the concavities 163 of the second friction washers 157B. After this, the friction engagement members 160 drives both the first and second friction washers 157A and 157B, causing them to slide in relation to the flexible plate 111 and the input friction plate 158.

In summation, driving the friction washer 157 with the aid of the first plate 132 yields an area in which some number of plates is driven to generate an intermediate frictional resistance in the torsion characteristics before the start of the large frictional resistance area in which all of the plates are driven.

2-1) Small Torsional Vibrations

The operation of the damper mechanism 104 when small torsional vibrations caused by combustion fluctuations of the engine are input to the double mass flywheel 101 is described below with reference to the mechanical circuit diagram in FIG. 18 and the diagrams of torsional characteristics in FIGS. 19 to 21.

When small or minute torsional vibrations are input, the input disk-like plate 120 in the second friction generation mechanism 106 rotates relative to the friction washer 157 in the rotational direction gap 165 between the friction engagement member 160 and the concavities 163. In other words, the friction washer 157 is not driven with the input disk-like plate 132, and the friction washer 157 therefore does not rotate in relation to the member on the input side. As a result, high hysteresis torque is not generated for small torsional vibrations. That is, although the coil springs 134 and 136 operate at “AC 2HYS,” for example, in the diagram of torsional characteristics in FIG. 19, slippage does not occur in the second friction generation mechanism 106. That is to say, only a hysteresis torque that is much smaller than normal hysteresis torque can be obtained in a prescribed range of torsion angles. Thus, the vibration and noise level can be considerably reduced because a very narrow rotational direction gap is provided in which the second friction generation mechanism 106 does not operate in the prescribed angle range.

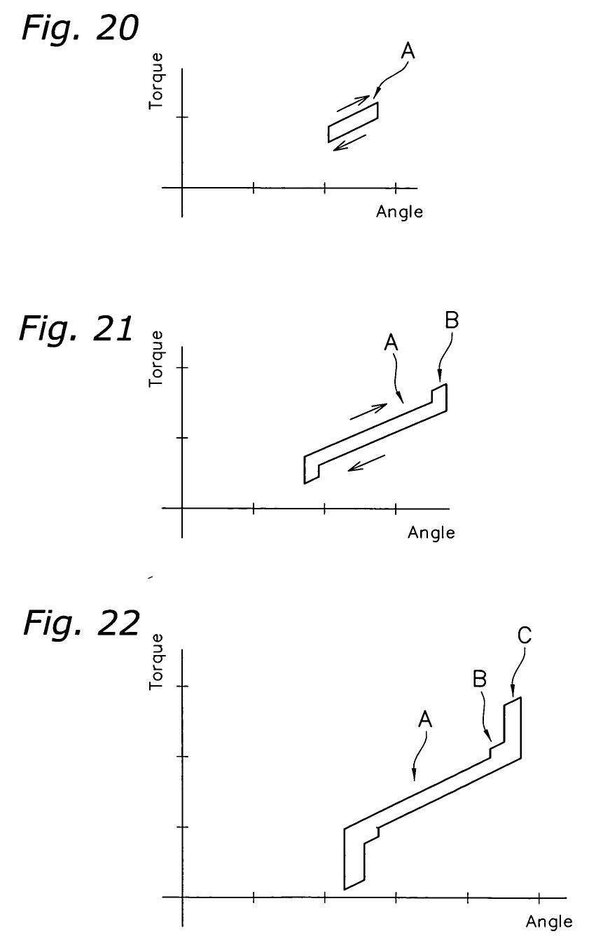

As a result, when the operating angle of the torsional vibration is equal to or less than the angle (8°, for example) of the first rotational direction gap 165A of the first engagement portion 164A of the first friction washers 157A, large frictional resistance (high hysteresis torque) is not generated at all, and only area A of low frictional resistance is obtained in the second stage of torsion characteristics, as shown in FIG. 20. Moreover, when the operating angle of the torsional vibration is equal to or greater than the angle (8°, for example) of the first rotational direction gap 165A of the first engagement portion 164A of the first friction washers 157A, and is equal to or less than the angle (10°, for example) of the second rotational direction gap 165B of the second engagement portion 164B of the second friction washers 157B, the area B of intermediate frictional resistance is generated on the edge of the area A of low frictional resistance, as shown in FIG. 21. When the operating angle of the torsional vibration is equal to or greater than the angle (10°, for example) of the second rotational direction gap 165B of the second engagement portion 164B of the second friction washers 157B, the area B of intermediate frictional resistance and the area C in which some large frictional resistance is generated are respectively obtained on both edges of the area A of low frictional resistance, as shown in FIG. 22.

2-2) Wide-Angle Torsional Vibrations

As described above, when the torsional angle of the torsional vibration is large, the friction washers 157 rotate together with the friction engagement members 160 and the first plate 132 and slide against the flexible plate 111 and the input friction plate 158. As a result, the friction washers 157 slide against the flexible plate 111 and the input friction plate 158 to generate a frictional resistance over the entire range of torsional characteristics.

Here, the operation in the edge portion (position in which the direction of the vibration changes) of the torsion angle is described. At the right-hand edge of the torsion characteristic line chart of FIG. 19, the friction washer 157 is shifted most in the rotational direction R2 in relation to friction engagement member 160. When the friction engagement member 160 twists from this state in the rotational direction R2 in relation to the output disk-like plates 132 and 133, the friction washers 157 and the friction engagement member 160 rotate relative to each other across the entire angle of the rotational direction gap 165 of the friction engagement member 160 and concavities 163. During this operation, the area A (8°, for example) of low frictional resistance can be obtained because the friction washers 157 do not slide against the member on the input side. Next, when the first rotational direction gap 165A of the first engagement portion 164A of the first friction washers 157A is no longer present, the first plate 132 drives the first friction washers 157A. Then, the first friction washers 157A rotate relative to the flexible plate 111 and the input friction plate 158. As a result, the area B of intermediate frictional resistance (2°, for instance) is generated as described above. When the second rotational direction gap 165B of the second engagement portion 164B of the second friction washers 157B is no longer present, the first plate 132 subsequently drives the second friction washers 157B. Then, the second friction washers 157B rotate relative to the flexible plate 111 and the input friction plate 158. The area C of comparatively large frictional resistance is generated because both the first friction washers 157A and the second friction washers 157B slide at this time. In addition, hysteresis torque generated by the friction washers 157A is lower than that generated by the second friction washers 157B and preferably the former is almost half of the latter in this embodiment.

As described above, the area B of intermediate frictional resistance is provided at an early stage of a large frictional resistance generation. A barrier of high hysteresis torque does not exist when a large frictional resistance is generated because the buildup of large frictional resistance is graduated in this manner. As a result, the knocking sound of the pawls when high hysteresis torque is generated decreases in a frictional resistance generation mechanism with a very narrow rotational direction gap to absorb small torsional vibrations.

In particular, the number of types of frictional members can be kept low in the present invention because a single type of friction washer 157 is used to generate intermediate frictional resistance. The friction washer 157 is also a simple structure that extends in the form of an arc. Furthermore, a through-hole in the axial direction is not formed in the friction washer 157, and thus, manufacturing costs can be kept low.

Advantages

3-1) First Friction Generation Mechanism

Sliding area of the first friction generation mechanism 105 is set relatively large because the first friction generation mechanism 105 makes use of a part of the second flywheel as a friction surface. Specifically, the second friction member 152 is urged against the second flywheel 103 by the cone spring 153. Accordingly, the pressure per area on the sliding surface is reduced so that the life of the first friction generation mechanism 105 is improved.

The radially outer portion of the second friction member 152 and the radially inward portion of the first and second coil springs 134 and 135 are overlapped in the axial direction. That is to say, radial position of the outer circumferential edge of the second friction member 152 is radially outward of radial position of the inner circumferential edge of the first and second coil springs 134 and 135. Accordingly, although the second friction member 152 and the first and second coil springs 134 and 135 are very close to each other in the radial direction, it is possible to ensure enough friction area in the second friction generation mechanism 106,

Only the first friction member 151 is unrotatably engaged with the input disk-like plate 120 and the first friction member 151 and the second friction member 152 are engaged with each other unrotatably. Accordingly, it is unnecessary to engage the second friction member 152 with the input disk-like plate 120, thereby making the structure simpler.

As shown in FIGS. 10, 11, and 17, the first friction member 151 is composed of the annular portion 151a in contact with the first plate 132 to slide in the rotational direction, and a plurality of the engagement portions 151b and 51c extending from the annular portion 151a and engaging with the input disk-like plate 120 to move relatively in the axial direction but not in the rotational direction. The second friction members 152 are formed with a plurality of recesses 152a with which the engagement portions 151b and 151c are engaged so as to move in the axial direction but not in the rotational direction. Accordingly, it is easy to realize a structure in which the annular portion 151a of the first friction member 151 and the second friction member 152 are disposed apart from each other in the axial direction because the first friction member 151 has the engagement portions 151b and 151c extending axially.

The cone spring 153 is disposed between the second friction member 152 and the engagement portions 151b and 151c of the first friction member 151 and urges both the members in the axial direction, thereby making the structure simpler.

The washer 154 is seated on the tip of the engagement portions 151b and 151c of the first friction member 151 and receives the load from the cone spring 153. The washer 154 provides the axial load applied to the friction sliding surface stable so that the frictional resistance generated on the sliding surface becomes stable.

The first friction generation mechanism 105 is disposed radially inward of the clutch friction surface 103a of the second flywheel 103, apart from each other. Accordingly, the first friction generation mechanism 105 is unlikely to be affected by the heat from the clutch friction surface 103a, thereby stabilizing frictional resistance.

The first friction generation mechanism 105 is disposed radially inward of the radial center of the first and second coil springs 135 and radially outward of the radially outermost edge of the bolts 122, thereby ensuring a structure with a small space.

3-2) Second Friction Generation Mechanism 106

As seen in FIGS. 4, 5 and 7, the second friction generation mechanism 106 is unlikely to be affected by the heat from the clutch friction surface 103a of the second flywheel 103 and has a stable characteristics because the second friction mechanism 106 is held by the first flywheel 102, more specifically the flexible plate 111. In particular, the first flywheel 102 is unlikely to receive the heat from the second flywheel 103 because the first flywheel 102 is connected to the second flywheel 103 by way of the coil springs 134-136.

The second friction generation mechanism 106 makes use of the annular portion 111a of the flexible plate 111 as a friction surface so that the number of components of the second friction generation mechanism 106 is reduced and the structure simplified.

The second friction generation mechanism 106 is disposed radially outward of the clutch friction surface 103a and apart from each other in the radial direction so that the second friction generation mechanism 106 is unlikely to be affected by the heat from the clutch friction surface 103a.

3-3) Flexible Flywheel (First Flywheel 102 and Damper Mechanism 104)

The first flywheel 102 is composed of the inertia member 113 and the flexible plate 111 to connect the inertia member 113 to the crankshaft 191 and elastically deformable in the bending direction of the crankshaft 191. The damper mechanism 104 is composed of the input disk-like plate 120 to which the torque is inputted from the crankshaft 191, the output disk-like plates 132 and 133 disposed rotatable relative to the input disk-like plate 120, and the coil springs 134-136 to be compressed in the rotational direction by the relative rotation of both the members. The first flywheel 102 can move in the bending direction with a limit relative to the damper mechanism 104. A combination of the first flywheel 102 and the damper mechanism 104 constitute a flexible flywheel.

When the bending vibrations are inputted to the first flywheel 102, the flexible plate 111 deforms in the bending direction to absorb the bending vibrations from the engine. In this flexible flywheel, the bending vibration absorption effect by the flexible plate 111 is very high because the first flywheel 102 can move in the bending direction relative to the damper mechanism 104.

The flexible flywheel further includes the second friction generation mechanism 106. The second friction generation mechanism 106 is disposed between the first flywheel 102 and output disk-like plate 132 of the damper mechanism 104 and operate in parallel with the coil springs 134-136 in the rotational direction. The second friction generation mechanism 106 has the friction washers 157 and the friction engagement members 160, which are engaged with each other so as not only to transmit the torque but also to move in the bending direction relative to each other. In this flexible flywheel, the first flywheel 102 can move relative to the damper mechanism 104 in the bending direction with a limit even though they are engaged with each other by way of the second friction generation mechanism 106 because two members are engaged with each other to move relatively in the bending direction. As a result, the bending vibration absorption effect by the flexible plate 111 is very high.

The friction washer 157 and the friction engagement member 160 are engaged with each other with the rotational direction gap 159 in the rotational direction. Large resistance is not generated by the relative movement in the bending direction because they are not in close contact with each other in the rotational direction.

The friction engagement member 160 is engaged with the output disk-like plates 132 and 133 to move in the axial direction. Therefore, axial resistance is unlikely to be generated between the friction engagement member 160 and the output disk-like plates 132 and 133 in the axial direction when the friction washer 157 moves together with the first flywheel 102 in the axial direction.

3-4) Third Coil Spring

Referring now to FIGS. 4 and 6, the third coil springs 136 starts operation in the area where torsional angle becomes large to apply adequate stopper torque to the damper mechanism 104. The third coil springs 136 are functionally disposed in parallel to the first and second coil springs 134 and 135 in the rotational direction.

The third coil spring 136 has wire diameter and coil diameter smaller than those of the first and second coil springs 134 and 135 respectively, almost half of those, thereby making the axial space of them smaller. As shown in FIG. 4, the third coil springs 136 is disposed radially outward of the first and second coil springs 134 and 135 and corresponds to the clutch friction surface 103a of the second flywheel 103. In other words, radial position of the third coil springs 136 is within an annular area defined by the inner circumferential edge and the outer circumferential edge of the clutch friction surface 103a.

In this embodiment, providing the third coil springs 136 improves the capability by raising the stopper torque and realizes a small space for the third coil springs 136 by the dimension and location of the third coil springs 136. Especially, the coil diameter of each third coil spring 136 is smaller than those of the first and second coil springs 134 and 135 so that the axial length of the whole area where the third coil spring 136 is disposed is relatively small. Preferably, the coil diameter of the third coil spring 136 is in the range of 0.3-0.7 of the coil diameter of the first and second coil springs 134 and 135. As a result, although the third coil springs 136 are disposed at a place corresponding to the clutch friction surface 103a of the second flywheel, where the axial thickness is the largest in the second flywheel 103, the axial length of the area where third coil spring 136 is disposed is relatively small, and, in fact, is smaller than the area where the first and second coil springs 134 and 135 are disposed.

In addition, radial position of the stopper mechanism 171 composed of the projections 120c of the input disk-like plate 120 and the contact portions 143 and 144 of the output disk-like plates 132 and 133 is within the annular area of the clutch friction surface 103a, and is disposed at the same radial position with the third coil springs 136. Therefore, the radial dimension of the whole structure becomes smaller compared to the structure where the members are located at different radial positions.

### Other Embodiments

Embodiments of the double mass flywheel in accordance with the present invention was described above, but the present invention is not limited to those embodiments. Other variations or modifications that do not depart from the scope of the present invention are possible. More particularly, the present invention is not limited by the specific numerical values of angles and the like described above.

In the above-described embodiment, two size types of the rotational direction gap of the engagement portion were used, but it is also possible to use three or more size types. In the case of three size types, the magnitude of the intermediate frictional resistance will have two stages (the case of the third embodiment described hereinafter).

The coefficients of friction of the first friction member and the second friction member are the same in the above-described embodiment, but these may also be varied. Thus, the ratio of the intermediate frictional resistance and large frictional resistance can be arbitrarily set by adjusting the frictional resistance generated by the first friction member and the second friction member.

In the above-described embodiment, the intermediate frictional resistance is generated by providing the friction engagement member with an equal size and concavities with different sizes, but the concavities may be set to an equal size and the size of the friction engagement member may be different. Furthermore, combinations of the friction engagement members and concavities with different sizes may also be used.

In the above-described embodiment, the concavity of the friction washer faces the internal side in the radial direction, but it may face the external side in the radial direction.

In addition, the friction washer in the above-described embodiment has concavities, but the friction washer may also have convexities. In this case, the input side disk-like plate has concavities, for example.

Furthermore, the friction washer in the above-described embodiment has a friction surface that is frictionally engaged with an input member, but it may also have a friction surface that is frictionally engaged with an output member. In this case, an engagement portion having a rotational direction gap is formed between the friction washer and an input side member.

As used herein, the following directional terms “forward, rearward, above, downward, vertical, horizontal, below, and transverse” as well as any other similar directional terms refer to those directions of a device equipped with the present invention. Accordingly, these terms, as utilized to describe the present invention should be interpreted relative to a device equipped with the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

This application claims priority to Japanese Patent Applications No. 2003-113115 and No. 2003-405316. The entire disclosure of Japanese Patent Applications No. 2003-113115 and No. 2003-405316 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A flywheel assembly for transmitting torque comprising:
a flywheel;
a damper mechanism being configured to connect elastically said flywheel to a crankshaft of an engine in a rotational direction; and
a support member being configured to support and to position said flywheel on said crankshaft in a radial direction.

2. The flywheel assembly according to claim 1, wherein said flywheel is formed with a inner circumferential surface, and
said support member is formed with an outer circumferential surface opposing said inner circumferential surface in the radial direction.

3. The flywheel assembly according to claim 2, wherein said support member has a cylindrical support portion having said outer circumferential surface.

4. The flywheel assembly according to claim 3, further comprising a radial bearing disposed between said outer circumferential surface of said support member and said inner circumferential surface of said flywheel.

5. The flywheel assembly according to claim 4, wherein said radial bearing is composed of a cylindrical member.

6. The flywheel assembly according to claim 5, wherein said radial bearing further includes a thrust bearing portion that extends radially outward from said cylindrical member.

7. The flywheel assembly according to claim 5, wherein said support member has a fix portion to be fixed to a tip of said crankshaft.

8. The flywheel assembly according to claim 7, wherein said fix portion is annular flat disc-like portion and said support portion extends in the axial direction from an edge of said fix portion.

9. The flywheel assembly according to claim 8, further comprising an inertia member separately formed from said support member.

10. The flywheel assembly according to claim 8, further comprising a fix member for fixing said support member and said inertia member to said crankshaft.

11. The flywheel assembly according to claim 10, wherein said support member contacts said inertia member to center said inertia member in the radial direction.

12. The flywheel assembly according to claim 3, wherein said support member has a fix portion to be fixed to a tip of said crankshaft.

13. The flywheel assembly according to claim 12, wherein said fix portion is annular flat disc-like portion and said support portion extends in the axial direction from an edge of said fix portion.

14. The flywheel assembly according to any of claims 1, further comprising an inertia member separately formed from said support member.

15. The flywheel assembly according to claim 14, further comprising a fix member for fixing said support member and said inertia member to said crankshaft.

16. The flywheel assembly according to claim 14, wherein said support member contacts said inertia member to center said inertia member in the radial direction.

17. The flywheel assembly according to claim 1, wherein said damper mechanism includes an input member attached to said crankshaft, said input member being independent of and separate from said support member.

18. The flywheel assembly according to claim 17, further comprising a fix member to fix said support member and said input member to said crankshaft.

19. The flywheel assembly according to claim 18, wherein said support member contacts said input member to center said input member in the radial direction.

20. The flywheel assembly according to claim 1, wherein said crankshaft has an annular protrusion having an outer circumferential surface, which supports an inner circumferential surface of said support member.
